(19) United States
(12) Patent Application Publication
(10) Pub. No.: US 2011/0054085 A1
(43) Pub. Date: Mar. 3, 2011

(54) LABEL FOR POLYMER GEL AND METHODS THEREOF

(75) Inventors: Pierre Sévigny, Montreal (CA); Jacques Primeau, Repentigny (CA); Nina Duru, Brossard (CA)

(73) Assignee: DGel Sciences, Montreal (CA)

(21) Appl. No.: 12/870,110

(22) Filed: Aug. 27, 2010

Related U.S. Application Data
(60) Provisional application No. 61/237,888, filed on Aug. 28, 2009.
(60) Provisional application No. 61/328,207, filed on Apr. 27, 2010.

(51) Int. Cl. C09D 5/44

(52) U.S. Cl. 524/35; 106/31.94; 977/773

(57) ABSTRACT

There is provided a marking composition containing a water soluble cellulose, a mineral marker; and water, and method of marking a gel and a gel mold with an indicia prepared with the marking composition.

### BACKGROUND

(a) Field

The subject matter disclosed generally relates to marking compositions and methods thereof. More particularly, the subject matter relates to marking compositions for labelling polymer gels and methods of using the compositions.

(b) Related Prior Art

Gel electrophoresis is one of the most widely used analytical procedures in biotechnology for the separation of both proteins and nucleic acids from complex samples. Gel electrophoresis offers a sensitive, rapid means of separating, identifying and quantifying biologically relevant molecules. The configuration and size of the gel can vary, depending on the type of separation. Once separated, the molecules of interest can be detected and identified or quantified directly by comparison to standards, or interrogated further by diverse methods such as hybridization to tagged probes, immunochemical detection or analysis by mass spectrometry.

The reading of a gel can be performed either visually by the user or by automated detection systems. Certain indicia are often included in the reading procedure to assist in the identification of the sample components and to minimize the occurrence of errors. These indicia may consist of gel orientation guides, migration distance indicators, lane indicators, sample identifiers, the supplier's catalog numbers, and even the supplier's logo. Barcodes may be used to provide some of these indicia, while others may be simple letters, numbers or grid lines and similar markings. Indicia can also help avoid mistaking one gel for another when different gels have been simultaneously stained and washed, as is typically done prior to the reading of a gel to make the bands or spots readily detectable. Indicia can thus be useful in many ways, but to be effective, the indicia must not interfere with the electrophoretic separation or impose limitations on the processing and handling of the gel that occur after the separation is completed. These needs have presented a challenge to gel manufacturers and users.

A common means of applying indicia in the prior art is the embedding of a paper label in the gel. As the gel becomes enlarged during processing, however, paper labels often curl and tear, and even when they remain intact, paper labels tend to become stained, obscuring the indicia. Furthermore, another problem of paper labels is susceptible of tearing the gel when it is manipulated, because the label is less flexible and has a different weight than the gel. A gel labeling method that does not involve the use of paper labels is disclosed in U.S. Pat. No. 7,361,260 B2 to Amshey et al. The method uses a backing consisting of a solid transparent sheet on one side of the gel. The gel is chemically bonded to the backing to ensure secure adherence, and the desired indicia are imprinted on the backing sheet. The gel is formed over the backing by polymerizing the gel from a monomer solution that is in direct contact with the backing while forming covalent bonds between the gel and functional groups on the backing. Regardless of how the backing sheet is made to adhere to the gel, the sheet itself presents problems during the staining of the gel. Staining is performed by immersing the gel in a staining solution and allowing the solution to penetrate the gel from all sides. When this is done with gels that have a backing sheet, penetration occurs only from the exposed side, and this requires more time for proper staining to occur. This results in low efficiency, sensitivity and reliability.

Another means of applying indicia in the prior art is a method for forming an electrophoresis gel with indicia that are incorporated directly in the gel. U.S. Pat. No. 6,986,836 to Panattoni et al. describes electrophoresis gels prepared with indicia incorporated into the gel itself by printing a formulation of ink dissolved in a polymer solution. The method involves printing the ink formulation either on the internal surface of a mold pre-coated with a water-permeable polymer, either on a sheet which is then placed on the mold internal surface, or either by directly printing the indicia on the mold internal surface without coating it first. Although inks that are insoluble in the gel liquid are used for this method, these molecules or pigments are difficult to use since they tend to “run” or “bleed”, potentially producing distorted indicia when placed in contact with the bulk of the gel liquid. Also, these molecules or pigments are often toxic, which prevents their use in applications to gels prepared for human consumption (e.g. Jello™).

### SUMMARY

In a first embodiment there is disclosed a marking composition containing a water soluble cellulose, a mineral marker and water.

The marking composition may contain glycerol.

The water soluble cellulose may be methylcellulose, hydroxypropyl cellulose, hydroxypropyl methylcellulose, Methocel® MC, carboxymethyl cellulose, ethyl cellulose, and any combination thereof. The water soluble cellulose may be added in about 1% by weight to about 10% by weight of the composition, and preferably in about 1.25% by weight of the composition.

The mineral marker may be gesso, acrylic gesso, calcium carbonate, calcium sulphate, a mixture of calcium carbonate and at least one acrylic polymer, and any combination thereof.

The marking composition may also contain flattening powder.

The flattening powder may be chosen from 4105 flattening powder, FP-084 flattening powder, SIPI413 Universal Flattening Powder, SIPI440 TS-100 Flattening Powder, SIPI414 Cab-o-Sil PTG Thickening Powder, CM0571096 flattening powder, FL-0001 universal flattening powder, FL-0005 universal flattening powder, PT-83 Flattening Powder, FL-0001 flattening powder, KC-8211 Flattening Powder, KC-8212 Thickening Powder, and MLC 500 flattening, and combinations thereof.

The flattening powder may be added to the marking composition in about 1% by weight to about 10% by weight of the composition, preferably in 2.5% by weight of the composition.

The marking may contain glycerol in about 10% by volume to about 30% by volume of the composition, and preferably in about 20% by volume of the composition.

The marking composition may contain a coloring agent chosen from a pigment and a colorant.

The pigment may be carbon black, carbon ivory bone pigment, Indian black ink, Arabic gum, and titanium dioxide, and Printex® 35 carbon black, and preferably the pigment is carbon ivory bone pigment.

The pigment is from about 5% by weight to about 20%, and preferably the pigment is added in 10% by weight of the composition.

The marking composition may contain a rare earth element.

The rare earth element may be scandium, yttrium, lanthanum, cerium, praseodymium, neodymium, promethium, samarium, europium, gadolinium, terbium, dysprosium, holmium, thulium, ytterbium, and lutetium or any combinations thereof.

The marking composition may contain a nanoparticle.

The marking composition may contain a microbead.

In another embodiment, there is disclosed an ink marking composition comprising glycerol, a coloring agent, a humectant; and a quick setting agent.

The glycerol may be from about 10% to about 70%.

The coloring agent may be at least one of a pigment, a dye and a colorant.

The pigment may be at least one of platinum powder, titanium powder, gold powder, ferric oxide powder, lead powder, carbon powder, Cobalt powder, Mo Powder, Silver flake, Silver powder, Tungsten (W) powder, Tungsten (W) granule, Cr₃C₂ Powder, Tantalum Carbide powder, TaC—NbC Solid Solution Powder, Nano silver powder, Conductive Silver Powder, Nano silver powder, Nano Ferric Oxide, Nano zinc oxide, magnesium powder, copper powder, bronze powder, Aluminum powder paste, carbon black, carbon ivory bone pigment, Indian black ink, Arabic gum, and titanium dioxide, and Printex® 35 carbon black.

The pigment may be Silver powder.

The dye may be at least one of a black dye, a cyan dye, a magenta dye and a yellow dye.

The coloring agent may be from about 0.5% to about 20% by weight.

The coloring agent may be from about 1.5% to about 6% by weight.

The humectants may be at least one of ethylene glycol, polyethylene glycol 200, polyethylene glycol 300, polyethylene glycol 400, polyethylene glycol 600, polyethylene glycol 200-600, N-methyl-2-pyrrolidone, 2-pyrrolidone, diethylene glycol, triethylene glycol, propylene glycol, thiodiethanol, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol and monoethyl ether.

The humectant may be N-methyl-2-pyrrolidone.

The humectants may be from about 5% to about 80% by weight, or the humectants may be from about 10 to about 40% by weight.

The ink marking composition may comprise a fungicide.

The fungicide may be at least one of sodium dehydroacetate, sodium sorbate, 2-pyridine thiol-1-oxide sodium salt, sodium benzoate and sodium pentachlorophenol, Proclin® 150, and Kathon.

The ink marking composition may comprise a chelating agent.

The chelating agent may be at least one of ethylenediaminetetraacetate (EDTA), trisodium nitrilotriacetate, hydroxyethyl ethylenediamine trisodium acetate, diethylene triamino pentasodium acetate and uramil disodium acetate.

The ink marking composition may comprise a pH adjusting agent.

The pH adjusting agent may be at least one of diethanolamine, triethanolamine, lithium hydroxide, sodium hydroxide, potassium hydroxide, ammonium hydroxide, lithium carbonate, sodium carbonate and potassium carbonate.

The pH may be from about 9 to about 11.

In another embodiment there is disclosed a gel marked with the marking composition.

The gel may be an agarose gel or a polyacrylamide gel.

In yet another embodiment there is disclosed a method of marking a gel mold with a detectable indicia by forming the detectable indicia on a gel mold using the gel marking composition.

The following terms are defined below.

The term “indicia” is intended to mean markings of any kind. If the gel is a precast gel, the indicia may be the type of information that might be incorporated by the manufacturer, including, but not limited to, a barcode, a set of grid lines across the entire gel, length indicators (i.e., “rulers”) along the edge of the gel, lane numbers, reference points for manual or automated detection, a supplier catalog number, a supplier logo, or information regarding the gel composition such as its gel type or gel percentage. Alternatively, the indicia may be markings that can be applied by the user for gels that are prepared at the user site, such as a sample code number or other identifiers, the name of the user, the date on which the gel was prepared or the separation was performed, and the composition of the gel, including information relating to concentrations or gradients.

The term “gel” is intended to mean solid or semi-solid substance. Gels are typically made from materials such as polyacrylamide, polyacrylamide derivatives, agarose and starch. The liquid from which the gel is typically formed is a solution of monomer or other gel-forming material, and the gel is prepared by filling the gel mold, enclosure, cassette, container or bowl, with the solution and allowing the solution to solidify into a gel. The components used in forming the gels and the procedures are well known among those skilled in gel making. Preferred gels for electrophoresis are those made of crosslinked polyacrylamide, and are typically formed from an aqueous solution containing acrylamide monomer, a crosslinking agent, a catalyst and an initiator. The amounts of each of these components can vary widely, and the choice will depend on the concentrations and molecular weights of the solutes to be separated, as well as the type of electrophoretic separation. Other preferred gels for electrophoresis are agarose gels and are typically formed from an aqueous solution containing agarose sugar in a percentage from about 5% to about 20%. Other gel types are used in the food industry and include gels made from agarose, starch, and gelatin, for example.

The term “gel-forming liquid” is intended to mean a conventional liquid preparation that are poured, pumped, or otherwise placed inside gel molds where they are allowed to solidify into gels suitable for electrophoresis. As noted above, the mold for a slab gel typically consists of two flat plates separated by spacers that define the thickness or depth of the gel. Molds for gels of other configurations, such as tube gels, gel strips, and continuous closed cylindrical gels, are shaped accordingly. The molds may also be containers used to receive food. The gel-forming liquid may be a monomer solution that is allowed to polymerize or solidify in the mold cavity. Alternatively, the gel-forming liquid may be a solution of a polymer or other material that is placed in the cavity and then exposed to heat or any other form of energy that will cause the material to solidify into a gel. A further alternative is a gel solution that is hot when added to the cavity and then gels upon cooling.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

FIG. 1 illustrates a gel mold (a cassette) with a polyacrylamide gel with an indicia printed with a composition according to the present invention.

FIG. 2 illustrates a gel mold (a cassette) with a polyacrylamide gel with an indicia printed with a composition according to the present invention.

### DETAILED DESCRIPTION OF THE PREFERRED EMBODIMENTS

In embodiments there are disclosed a marking composition and methods of marking gel molds and gels with the compositions.

The marking composition comprises a number of ingredients selected from groups of possible components.

Water Soluble Celluloses

Celluloses are organic compounds with the general formula (C₆H₁₀O₅)ₙ, a polysaccharide consisting of a linear chain of several hundred to over ten thousands β(1→4) linked D-glucose units. Preferred celluloses include water-soluble celluloses, and modified water-soluble celluloses such as those known in the art and have properties similar to cellulose. Examples are methylcellulose of different viscosity, ethylcellulose, hydroxypropyl cellulose, hydroxymethylcellulose, and hydroxyethylcellulose, hydroxypropyl methylcellulose, Methocel® MC, and carboxymethylcellulose. These cellulose compounds, like cellulose itself, are not digestible by humans, and they are not toxic, and not allergenic. Celluloses may be added directly, in solid form, to the liquid preparation.

Mineral Markers

Mineral markers include gesso and acrylic gesso, which are used by artists for surface preparation or primer for painting. Gesso preparations will vary according to their intended use but will usually contain calcium carbonate mixed with a glue, and may possibly include some pigment. A more modern form of gesso has also been prepared with calcium carbonate mixed with acrylic polymers and his referred to as acrylic gesso. Therefore, suitable preparations of calcium carbonate and acrylic polymers that are not typical gesso may also be suitably used in the present invention.

Calcium carbonate may also be used as a mineral marker in the present invention. It is a chemical compound with the chemical formula CaCO₃, and is a common substance found in rock in all parts of the world. Calcium carbonate is commonly used medicinally as a calcium supplement or as an antacid and is therefore non-toxic, although high consumption can be hazardous.

Calcium sulphate may also be used as a mineral marker in the present invention. It is a common laboratory and industrial chemical. In the form of y-anhydrite (the nearly anhydrous form), it is used as a desiccant. It is also used as a coagulant in products like tofu. It is therefore a non-toxic chemical. The hemihydrate (CaSO₄.˜0.5H₂O) is better known as plaster of Paris, while the dihydrate (CaSO₄.2H₂O) occurs naturally as gypsum.

Flattening Powder

Flattening Powder is used to change the gloss level of various ink solutions to a satin or flat finish. Only 1 to 10% of flattening powder needs to be added by weight to change an ink's gloss level. Flattening power increases the viscosity of the ink solution. It also facilitates drying. Fattening powder The preferred flattening powder may be chosen from 4105 flattening powder, FP-084 flattening powder, SIPI413 Universal Flattening Powder, SIPI440 TS-100 Flattening Powder, SIPI414 Cab-o-Sil PTG Thickening Powder, CM0571096 flattening powder, FL-0001 universal flattening powder, FL-0005 universal flattening powder, PT-83 Flattening Powder, FL-0001 flattening powder, KC-8211 Flattening Powder, KC-8212 Thickening Powder, and MLC 500 flattening powder (commercially available from Sherwin Williams, Nazdar, TW Graphics, CRS Intl Inc). The most preferred flattening powder is 4105 flattening powder.

Glycerol

Glycerol (C₃H₅(OH)₃) is a chemical compound also commonly called glycerin or glycerine. It is a colorless, odorless, viscous liquid that is widely used in pharmaceutical formulations. For human consumption, glycerol is classified by the FDA among the sugar alcohols as a caloric macronutrient. Glycerol is sweet-tasting and of low toxicity. Glycerol has three hydrophilic hydroxyl groups that are responsible for its solubility in water and its hygroscopic nature. The addition of glycerol to the composition of the present invention stabilizes the composition and allows preservation of the composition and gels labeled with the composition of the present invention over extended periods of time. Glycerol may be included to the present invention in about 10% to about 30% by volume of the composition, and preferable in about 20% by volume of the composition.

Pigments and Colorants, and Rare Earth Elements

Several elements may be added to the composition of the present invention in order to customize or allow readability of the thus prepared indicia in specific use conditions (e.g. under UV or laser light), for example.

Pigments and colorants may be used to color the composition of the present invention as coloring agents. Pigments and colorants are material that changes the color of light it reflects as the result of selective color absorption. Pigments are often insoluble and are usually in suspension in the vehicle used to suspend them. Colorants includes elements such as dyes, paints and inks. Pigments may be of organic or biological origin. Preferred coloring agents used should not “run” or “bleed” thus distorting the printed indicia. Preferred pigments include but are not limited to carbon black, carbon ivory bone pigment, Indian black ink, Arabic gum, Printex® 35 carbon black (from Carmona Corp) and titanium dioxide.

Pigments and colorants may be added to the composition in about 5% to about 20% by weight of the composition, and most preferably in about 10% by weight of the composition.

Rare earth elements or rare earth metals are a collection of seventeen chemical elements in the periodic table, namely scandium, yttrium, and the fifteen lanthanoids: lanthanum, cerium, praseodymium, neodymium, promethium, samarium, europium, gadolinium, terbium, dysprosium, holmium, thulium, ytterbium, and lutetium. Scandium and yttrium are considered rare earths elements since they tend to occur in the same ore deposits as the lanthanoids and exhibit similar chemical properties.

In addition to rare earth elements, nanoparticles, and microbeads may also be used to allow the printed indicia to be visualized under fluorescence or phosphorescence.

Use of the Marking Composition

The composition of the present invention may be used over a laser engraved surface, then apply the marking composition in the groove forming letters, numbers or shapes. The composition may be applied by brush painting, stamp printing, stamping, over a stencil, through silk printing, or with an ink jet type printer. The marking composition can also be applied as a square and the letters, numbers or shapes can be applied after drying using an inkjet printer, pen, pencil, markers.

Any surface that may normally receive a regular ink solution may be suitable to receive the marking composition of the present invention. The marking composition will suitably be applied and will dry and harden. Typical surfaces include but are not limited to plastic surfaces, including films and including any plastic polymer, glass surfaces, paper and cardboard surfaces. Upon application of any marking composition according to the present invention, in liquid form, the liquid composition is susceptible to solidification upon contact with the surface upon which it is applied to, in the same manner that water turns into ice when entering in contact with a cold surface. This occurs in addition to the other means of solidification that are present in the compositions of the invention when in enters the gel poured in contact with the composition.

The present invention also includes marking compositions that are suitable for transfer to a gel matrix upon contact with a surface (e.g. a plastic surface) marked with a marking composition according to one embodiment of the present invention. Such marking composition may be prepared from a number of key basic elements that may be used alone, or in combination with the gel marking composition described above, which would then be supplemented with the basic elements.

The composition may be used in different manners. For example, the composition may be used to print an indicia on a cassette, cast or surface, and a gel put into contact with the printed indicia which will then transfer to the gel, marking it in the process. The composition may be used in any suitable known method of applying ink, such as engraving, inkjet printing, offset printing, stamping or any others applicable method.

Humectants

The marking composition contains one or more humectants. Suitable humectants, which often are chosen from water-soluble organic solvents, include ethylene glycol, glycerine (glycerol), polyethylene glycol (PEG), from about 200 to 600 MW (e.g. PEG 200, 300, 400, 600, or mixture thereof, for example PEG 200-600), N-methyl-2-pyrrolidone, and 2-pyrrolidone. Other possible humectants are diethylene glycol, triethylene glycol, propylene glycol, thiodiethanol, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, and triethylene glycol monoethyl ether. The humectants can be included in the range of about 5% to about 80% by weight, and more preferably 10% to 40% by weight.

Pigments and Colorants

Several elements may be added to the composition of the present invention in order to customize or allow readability of the prepared indicia in specific use.

Pigments and colorants may be used to color the composition of the present invention as coloring agents. Pigments and colorants are material that changes the color of light it reflects as the result of selective color absorption. Pigments are often insoluble and are usually in suspension in the vehicle used to suspend them. Colorants include elements such as dyes, paints and inks. Pigments may be of organic or biological origin. Preferred coloring agents used should not “run” or “bleed” thus distorting the printed indicia. Preferred pigments and dyes include but are not limited to carbon black, carbon ivory bone pigment, Indian black ink, Arabic gum, Printex® 35 carbon black (from Carmona Corp), titanium dioxide, platinum powder, titanium, gold, ferric oxide, lead, carbon, Cobalt, Mo Powder, Silver flake, Silver powder, Tungsten (W) powder, Tungsten (W) granule, Cr3C2 Powder, Tantalum Carbide powder, TaC—NbC Solid Solution Powder, Nano silver powder, Conductive Silver Powder, Nano silver powder, Nano Ferric Oxide, Nano zinc oxide, magnesium powder, copper powder, bronze powder, Aluminum powder paste. Classic commercially available dyes such as black dyes, cyan dyes, magenta dyes and yellow dyes can also be used.

Pigments, colorants and dyes may be added to the composition in about 0.5% to about 20% by weight of the composition, preferably, and most preferably in about 1.5 to 6% by weight of the composition.

Other Components

In addition to the basic elements mentioned above, the marking composition may contain fungicides and preservative, such as sodium dehydroacetate, sodium sorbate, 2-pyridine thiol-1-oxide sodium salt, sodium benzoate and sodium pentachlorophenol, Proclin® 150, and Kathon. These other components may be added to the marking composition from about 0.001% to about 5%.

The pH of the marking composition may be adjusted to fall within a pH range of about pH 9.0 to 11.0. Suitable pH adjusting agents that may be used are diethanolamine, triethanolamine, lithium hydroxide, sodium hydroxide and potassium hydroxide; ammonium hydroxide, lithium carbonate, sodium carbonate and potassium carbonate.

The marking composition may also contain chelating agents such as ethylenediaminetetraacetate (EDTA), trisodium nitrilotriacetate, hydroxyethyl ethylenediamine trisodium acetate (trisodium HEDTA), diethylene triamino pentasodium acetate and uramil disodium acetate.

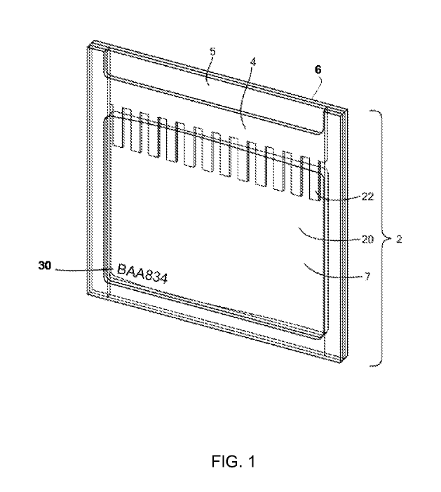

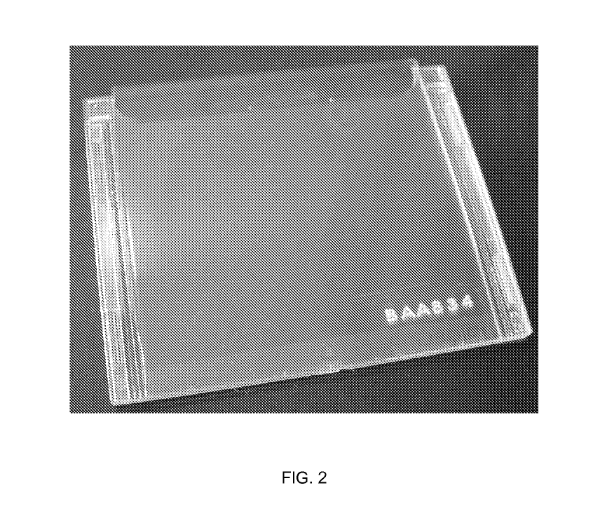

Now referring to FIG. 1, a mold for a gel 2, where a gel 20 has been cast. The comb 5 is inserted in the mold 2, near the top 4 of the front mold plate 7. The indicia 30 which had been printed on the interior surface of the back plate 6. FIG. 2 shows a black and white photograph of an actual gel marked with an indicia printed with the composition of the present invention.

### ALTERNATIVE EMBODIMENTS

### Example I

### Methylcellulose Solution Preparation 1

A first exemplary methylcellulose solution composition is prepared by mixing the following components:

| Component | Quantity | | Percentage |
|---|---|---|---|
| Methylcellulose | 25 | g | 2.5% (w/v %) |
| Acetonitrile | 400 | ml | 40% |
| Hot Water | 350 | ml | 35% |
| Cold Water | ~250 | ml | ~25% |

| | |
|---|---|
| Total volume | 1000 ml |

As a first step, water (350 ml) is heated to 80-90° C. and mixed with methylcellulose (25 g). Agitation is maintained until complete dissolution of methylcellulose powder in heated water. While continuing to be stirred, the solution is slowly cooled. The remaining water (250 ml) and acetonitrile (400 ml) are then gradually mixed with the solution. Stirred continuously, the mixture is cooled in ice during a period of about 35 minutes. The viscosity is then increased and the solution continues to be well mixed for about 35 more minutes at room temperature (RT). After degassing the solution twice (30 minutes+30 minutes), it is finally incubated at room temperature for 24 hours.

### Example 2

### Methylcellulose Solution Preparation 2

A second exemplary methylcellulose solution composition is prepared by mixing the following components:

| Component | Quantity | | Percentage |
|---|---|---|---|
| Methylcellulose | 10 | g | 2.5% (w/v %) |
| Acetonitrile | 160 | ml | 40% |
| BYK 141™ | 0.4 | ml | 0.1% |
| Hot Water | 200 | ml | 50% |
| Cold Water | ~40 | ml | ~9.9% |

| | |
|---|---|
| Total volume | 400 ml |

As a first step, water (200 ml) is heated at 80-90° C. and mixed with methylcellulose (10 g). Agitation is continued until complete dissolution of methylcellulose powder in heated water. While continuing to be well stirred, the solution is slowly cooled. The remaining water (about 40 ml) and acetonitrile (160 ml) must then be gradually mixed with the solution, along with the solution of foam destroying polysiloxanes BYK 141™. Stirred continuously, the mixture is cooled in ice during a period of about 35 minutes. The viscosity will then be increased and the solution will continue to be well stirred for about 35 more minutes at room temperature (RT). After degassing the solution twice (30 minutes+30 minutes), it is finally incubated at room temperature for 24 hours.

### Example 3

### Methylcellulose Solution Preparation 3

A third exemplary methylcellulose solution composition is prepared by mixing the following components:

| Component | Quantity | | Percentage |
|---|---|---|---|
| Methylcellulose | 2.5 | g | 2.5% (w/v %) |
| Methyl Ethyl Ketone | 40 | ml | 40% |
| Water | ~60 | ml | ~60% |

| | |
|---|---|
| Total volume | 100 ml |

First, water (60 ml) is mixed with methylcellulose (2.5 g). Agitation continues until complete dissolution of methylcellulose powder in water. While continuing to be well agitated, the solution is slowly cooled. Solvent (Methyl Ethyl Ketone) is gradually be added to the agitated mixture. Stirring continuously, the mixture is cooled on ice for increasing solution viscosity. The final step is to incubate the solution at RT.

### Example 4

### Methylcellulose Solution Preparation 4

A fourth exemplary methylcellulose solution composition is prepared by mixing the following components:

| Component | Quantity | | Percentage |
|---|---|---|---|
| Methylcellulose | 2.5 | g | 1.25% |
| Distilled Water | 150 | ml | 75% |
| Gesso¹ | 12.5 | g | 6.25% |
| Flattering powder | 5 | g | 2.5% |
| Glycerol | ~40 | ml | ~20% |
| Total volume | 200 | ml | |

First distilled water (50 ml) is heated at 95° C. and mixed with methylcellulose (2.5 g). Agitation is continued until complete dissolution of methylcellulose in heated water. The solution incubation continues firstly at 60° C. for a period of 30 minutes and secondly at room temperature overnight. Distilled water (20 ml) is added to the solution, is well mixed and incubated at RT for 30 more minutes. At this time, distilled water (30 ml), Gesso (12.5 g) and flattening powder (5 g) are incorporated to the solution and incubated at RT for a period of 30 minutes. Lastly, after the addition of Glycerol (40 ml) mixed with distilled water (about 50 ml) the mixture will be well mixed and stored, producing a total volume of 200 ml.

### Example 5

### Methylcellulose Solution Preparation 5

A fifth exemplary methylcellulose solution composition is prepared by mixing the following components:

| Component | Quantity | | Percentage |
|---|---|---|---|
| Methylcellulose | 2.5 | g | 1.25% |
| Hydroxypropyl | 2.5 | g | 1.25% |
| methylcellulose | | | |
| Distilled Water | ~150 | ml | ~75% |
| Gesso | 12.5 | g | 6.25% |
| Flattering powder | 5 | g | 2.5% |
| Glycerol | 40 | ml | 20% |
| Total volume | 200 | ml | |

In the first time, distilled water (50 ml) must be heated at 95° C. and mixed with methylcellulose and hydroxypropyl-methylcellulose (2.5 g each). Agitation must be continued until complete dissolution of methylcellulose and hydroxypropyl-methylcellulose in heated water. The solution is incubated firstly at 60° C. for a period of 30 minutes and secondly at room temperature overnight. Distilled water (20 ml) is added to the solution that is well mixed and incubated at RT for 30 more minutes. At this time, distilled water (30 ml), Gesso (12.5 g) and flattening powder (5 g) are incorporated to the solution which is incubated at RT for a period of 30 minutes. Lastly, after the addition of Glycerol (40 ml) mixed with distilled water (50 ml) the mixture will be well mixed and stored, producing a total volume of 200 ml.

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed.

1. A marking composition comprising:
a water soluble cellulose;
a mineral marker; and
water.

2. The marking composition of claim 1, further comprising glycerol.

3. The marking composition of claim 1, wherein the water soluble cellulose is chosen from methylcellulose, hydroxypropyl cellulose, hydroxypropyl methylcellulose, Methocel® MC, carboxymethyl cellulose, ethyl cellulose, and any combination thereof.

4. The marking composition of claim 1, wherein the mineral marker is chosen from gesso, acrylic gesso, calcium carbonate, calcium sulphate, a mixture of calcium carbonate and at least one acrylic polymer, and any combination thereof.

5. The marking composition of claim 3, wherein the water soluble cellulose is from about 1% by weight to about 10% by weight of the composition.

6. The marking composition of claim 5, wherein the water soluble cellulose is 1.25% by weight of the composition.

7. The marking composition of claim 1, further comprising a flattening powder.

8. The marking composition of claim 7, wherein the flattening powder chosen from 4105 flattening powder, FP-084 flattening powder, SIPI413 Universal Flattening Powder, SIPI440 TS-100 Flattening Powder, SIPI414 Cab-o-Sil PTG Thickening Powder, CM0571096 flattening powder, FL-0001 universal flattening powder, FL-0005 universal flattening powder, PT-83 Flattening Powder, FL-0001 flattening powder, KC-8211 Flattening Powder, KC-8212 Thickening Powder, MLC 500 flattening and combinations thereof.

9. The marking composition of claim 7, wherein the flattening powder is from about 1% by weight to about 10% by weight of the composition.

10. The marking composition of claim 9, wherein the flattening powder is 2.5% by weight of the composition.

11. The marking composition of claim 2, wherein glycerol is from about 10% by volume to about 30% by volume of the composition.

12. The marking composition of claim 11, wherein glycerol is 20% by volume of the composition.

13. The marking composition of claim 1, further comprising a coloring agent chosen from a pigment and a colorant.

14. The marking composition of claim 13, wherein the pigment is chosen from carbon black, carbon ivory bone pigment, Indian black ink, Arabic gum, and titanium dioxide, and Printex® 35 carbon black.

15. The marking composition of claim 13, wherein the pigment is carbon ivory bone pigment.

16. The marking composition of claim 14, wherein the pigment is from about 5% by weight to about 20% by weight of the composition.

17. The marking composition of claim 14, wherein the pigment is added in 10% by weight of the composition.

18. The marking composition of claim 1, further comprising a rare earth element.

19. The marking composition of claim 18, wherein the rare earth element is chosen from scandium, yttrium, lanthanum, cerium, praseodymium, neodymium, promethium, samarium, europium, gadolinium, terbium, dysprosium, holmium, thulium, ytterbium, and lutetium.

20. The marking composition of claim 1, further comprising a nanoparticle.

21. The marking composition of claim 1, further comprising a microbead.
